(19) United States
(12) Patent Application Publication
(10) Pub. No.: US 2024/0201345 A1
(43) Pub. Date: Jun. 20, 2024

(54) PROXIMITY DETECTION WITH AUTO CALIBRATION

(71) Applicant: ams-OSRAM Asia Pacific Pte. Ltd., Singapore (SG)

(72) Inventors: Vasanth Swaroop YADAGIRI, Eindhoven (NL); Dinesh KURUGANTI, Eindhoven (NL); Yadgiri ELE VIJAY, Eindhoven (NL); Sandeep VERNEKAR, Eindhoven (NL)

(21) Appl. No.: 18/286,051

(22) PCT Filed: Mar. 15, 2022
(86) PCT No.: PCT/SG2022/050130

§ 371 Date: Oct. 6, 2023

(30) Foreign Application Priority Data
Apr. 9, 2021 (GB) 2105080.2

(51) Int. Cl. G01S 7/497; G01S 17/04; G01S 17/08

(52) U.S. Cl. CPC G01S 7/497; G01S 17/04; G01S 17/08; G01S 2007/4975

(57) ABSTRACT

An optical device comprises an emitter for emitting light, a receiver for receiving reflected light and providing a data signal, a register for storing processing parameters comprising a baseline reference value, and a processing unit for processing the data signal using the processing parameters. The processing unit is configured to compare the data signal to the baseline reference value, and determine that a crosstalk calibration of the optical device is required based at least partially on the comparison.

### FIELD OF DISCLOSURE

The present disclosure concerns optical devices and particularly but not exclusively to proximity sensors with auto calibration.

### BACKGROUND

Proximity sensing, whereby the presence of and/or the distance to an object is measured, is used in many modern electronic devices including mobile devices such as smartphones. For example, a proximity sensor in a smartphone can be used to detect when the user puts the phone to his ear, in response to which the display may be turned off.

Optical proximity detection typically measures the intensity of reflected light to determine the distance to an object. A proximity sensor will always experience some level of unwanted crosstalk, wherein the received signal is a superposition of the “true” proximity data from the target reflection and the crosstalk. Crosstalk can arise from various sources such as internal reflections. In a proximity system, the optical crosstalk must be correctly measured under a ‘No Target’ condition and subtracted from the proximity measurement to get the true proximity data.

A crosstalk calibration is required when changes to conditions, which can change the crosstalk, occur. For example, when the proximity configurations settings are changed, or if there is a change in temperature or a smudge in the optical path. A change in the crosstalk effects the proximity data and can lead to an increase in the error failure rate. To avoid this, calibration should be done whenever the crosstalk changes. Generally this is triggered by application software.

There may also be an offset in the analogue front end (AFE) of the device, which causes a shift in the final code and appears as crosstalk. The crosstalk calibration may also compensate for this shift, and there is no need of an explicit electrical calibration.

In conventional proximity measurements, an additional emitter and/or sensor is used to detect the presence of a smudge on the screen. The sensor/emitter is physically placed such that a reflected signal is detected only if there is a smudge on the screen. Hence, by monitoring the signal level, the presence of a smudge is detected. In another approach, the application software monitors the proximity data's range and uses algorithms to detect a smudge.

Accordingly, a problem with conventional proximity sensors is the need for additional hardware (e.g. emitter and receivers) and/or the increased processing burden placed on the host application for analyzing the device data to detect the presence of a smudge in front of the sensor.

### SUMMARY

In order to solve at least some of the above described problems, the disclosure provides an optical device (typically a proximity sensor) with built in processing of the data signal provided by the device to determine if calibration of the device is required. Because the normal data signal (for example the proximity data signal) of the device is used, no additional emitters or receivers are required for detecting a smudge causing a change in crosstalk and hence requiring calibration. Furthermore, since the signal is processed at the device itself, the signal does not have to be constantly transmitted to and analyzed by external application software, which can therefore decrease the overhead on the host/software to track the data range that is used to detect a smudge.

According to a first aspect of the present disclosure there is provided an optical device comprising an emitter for emitting light, a receiver for receiving reflected light and providing a data signal, and a register for storing processing parameters comprising a baseline reference value The device further comprises a processing unit for processing the data signal using the processing parameters, wherein the processing unit is configured to compare the data signal to the baseline reference value, and determine that a crosstalk calibration of the optical device is required based at least partially on the comparison. Typically, the optical device is a proximity sensor and the data signal is a proximity data signal usable to determine the presence of or the distance to an object reflecting light emitted by the emitter and received by the receiver.

The processing unit can be configured to, in response to determining that crosstalk calibration is required, perform the crosstalk calibration, or flag to an external unit that a crosstalk calibration is required, wherein the processing unit is configured to receive a calibration trigger from the external unit and, in response to receiving the calibration trigger, perform the crosstalk calibration. Typically, the optical device is integrated in a mobile device such as a smartphone and sends a calibration request to the mobile device, which analyses the request and triggers calibration if required. However, the device may also be configured to automatically perform a calibration when it determines that calibration is required. The register can be configured by the external unit. For example, the external unit may set and maintain one or more processing parameters in the register. In particular, threshold values, averaging window size, and a persistence filter value may be programmable. The optical device may communicate with the external unit using, for example, an I2C protocol. Other possible communication protocols include SPI, I3C and UART or other custom or standard serial or parallel protocols.

The crosstalk calibration (also referred to simply as “calibration” herein) may comprise determining a crosstalk value being indicative of a level of optical crosstalk at the receiver, and wherein the processing unit is configured to subtract the crosstalk value from the data signal. The processing unit subtracts the crosstalk value to obtain the “true” data signal (e.g. the true proximity data for determining the presence of or distance to a target object).

The processing parameters may comprise a baseline window size (e.g. 2, 4, 8, 16, 32 etc.), and a no-target threshold value. The processing unit can be configured to determine a baseline value of the data signal by taking an average of the data signal in a window having the baseline window size while ignoring data signal values exceeding the no-target threshold. The processing unit is then configured to compare the data signal to the baseline reference value by comparing the baseline value to the baseline reference value. For example, comparing the baseline value to the baseline reference value comprises calculating an absolute difference between the baseline value and the baseline reference value and determining when the absolute difference exceeds a baseline threshold value in the register.

The register may further comprise a persistence value indicative of a time period, and a smudge threshold value. The processing unit can be configured to, in response to determining that the absolute difference exceeds the threshold value, determine if the baseline value exceeds the smudge threshold value over the time period. Typically, the time period is given by a number of consecutive cycles of baseline value measurements. For example, the persistence filter may be set to four, indicating a time period represented by four cycles, which then means that the sensor checks if the baseline value exceeds the smudge threshold value in four consecutive baseline value calculations. In response to determining that the baseline value exceeds the smudge threshold value over the time period, the processing unit is configured to determine that a crosstalk calibration is required. The processing unit may set a “smudge detected” flag to equal 1.

The optical device may further comprise a temperature sensor (e.g. a thermistor) for determining a temperature of or at the optical device. The processing parameters then comprise a temperature threshold value, and the processing unit is configured to compare the temperature of the optical device to the temperature threshold value, and when the temperature of the optical device exceeds the temperature threshold value, determine that a crosstalk calibration is required. The processing unit may set a “temperature exceeds threshold” flag to equal 1. Typically, the absolute difference between the temperature of the device and a nominal temperature (stored in the register) is taken and compared to the temperature threshold value. That way, both negative and positive temperature changes are detected using just the one threshold. After calibration, the nominal temperature may be updated to the current temperature.

Preferably, the processing unit is configured to determine that a crosstalk calibration is required when the optical device is turned on (i.e. when the optical device goes from “disabled” to “enabled”), since device setting which may impact crosstalk may change while the device is disabled.

According to a second aspect of the present disclosure, there is provided a system comprising a proximity sensor according to the first aspect, and a mobile device (e.g. a smartphone or smartwatch) connected to the proximity sensor and comprising application software. The application software is configured to set and maintain one or more of the process parameters in the register of the proximity sensor. The application software is further configured to receive a request for crosstalk calibration from the proximity sensor, and in response to receiving the request, determine whether or not to send a calibration trigger to the proximity sensor to cause the crosstalk calibration. The host application software may in take more factors into account for determining if device calibration is actually required.

According to a third aspect of the present disclosure there is provided a method of determining the presence of or distance to an object. The method may be carried out using an optical device according to the first aspect. The method comprises emitting light from an emitter, and receiving with a receiver light comprising light emitted from the emitter and reflected by the object, and providing a data signal usable for determining the presence of or the distance to the object. The method further comprises providing a register comprising processing parameters for processing the data signal comprising a baseline reference value, comparing the data signal to the baseline reference value, and determining that a crosstalk calibration of the optical device is required based at least partially on the comparison. The method further comprises determining the presence of or the distance to the object from the data signal. When there is a target, the data signal is used for proximity sensing, i.e. for detecting the target object. When there is no target (when the baseline value is below the no-target threshold) the data signal is used in the baseline computation as part of the algorithm for determining if a calibration is required.

The method may further comprise, in response to determining that crosstalk calibration is required, performing the crosstalk calibration, or flagging to an external unit that a crosstalk calibration is required, receiving a calibration trigger from the external unit and, in response to receiving the calibration trigger, performing the crosstalk calibration.

The processing parameters may comprise a baseline window size (e.g. 2, 4, 8, 16, 32 etc.), a baseline threshold value, and a no-target threshold value. The method may then further comprise determining a baseline value of the data signal by taking an average of the data signal in a window having the baseline window size while ignoring data signal values exceeding the no-target threshold value, and comparing the data signal to the baseline reference value by taking an absolute difference between the baseline value and the baseline reference value and determining when the absolute difference exceeds the baseline threshold value.

The register may further comprise a persistence value indicative of a time period (typically a number of consecutive baseline value cycles/calculations), and a smudge threshold value. The method may then further comprise, in response to determining that the absolute difference exceeds the threshold value, determining if the baseline value exceeds the smudge threshold value over the time period, and, in response to determining that the baseline value exceeds the smudge threshold value over the time period, determining that a crosstalk calibration is required. Alternatively or in addition, the register may comprise a temperature threshold value and the method may comprises, in response to determining that the absolute difference exceeds the baseline threshold value, measuring a temperature, comparing the temperature to a nominal temperature, and when an absolute difference between the temperature and the nominal temperature exceeds the temperature threshold value, determining that a crosstalk calibration is required.

### BRIEF DESCRIPTION OF THE PREFERRED EMBODIMENTS

Specific embodiments of the disclosure are described below with reference to the accompanying drawings, wherein

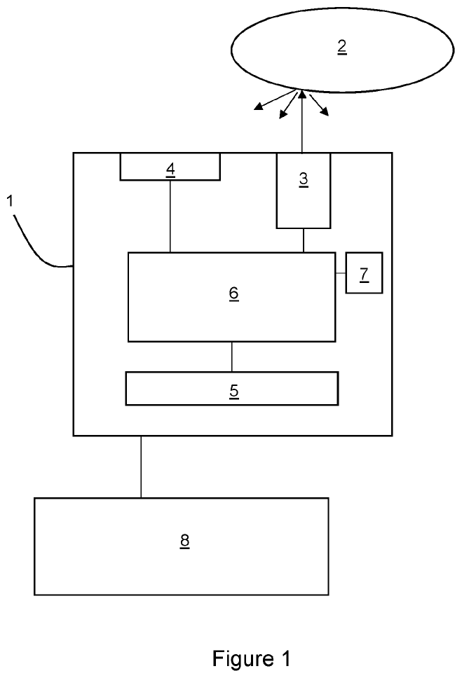

FIG. 1 depicts an optical device according to an embodiment of the disclosure;

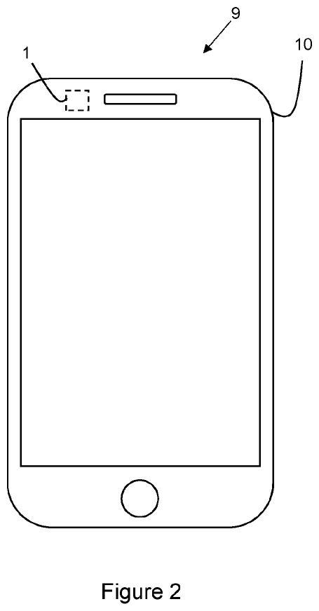

FIG. 2 depicts a system comprising an optical device according to an embodiment;

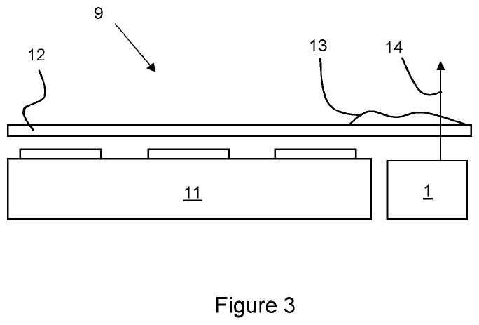

FIG. 3 depicts another system comprising an optical device according to an embodiment;

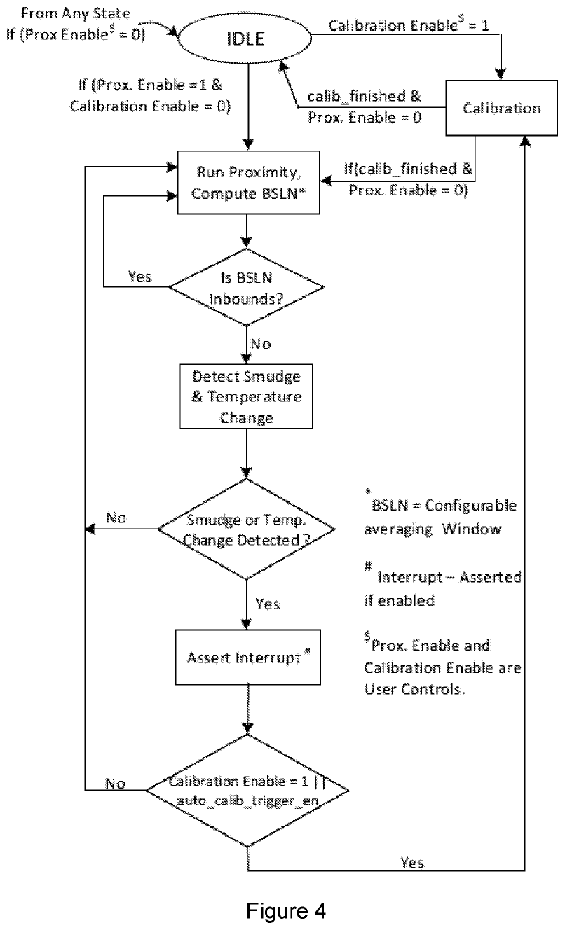

FIG. 4 depicts a flow diagram illustrating the operations of an optical device according to an embodiment; and

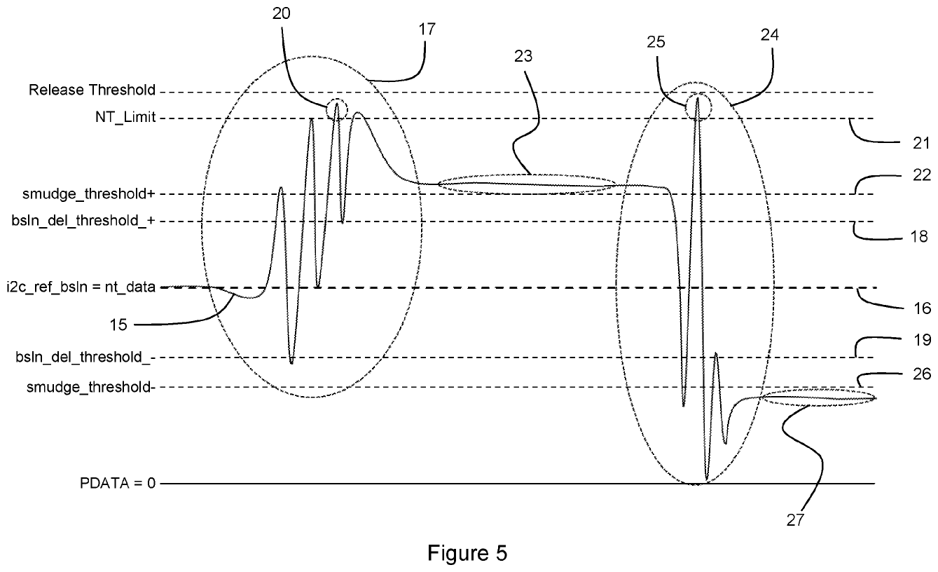

FIG. 5 depicts a graph of a proximity data signal over time in relation to different processing parameters of an optical device according to an embodiment.

### DETAILED DESCRIPTION

FIG. 1 shows a schematic diagram of an optical device 1 being a proximity sensor for determining the presence of and/or the distance to an object 2. The proximity sensor comprises an emitter 3 for emitting light (e.g. IR light), which is reflected from the object 2 and received by the receiver 4. The receiver 4 may comprise receiving circuitry such as an analogue to digital convert (ADC). The receiver 4 converts the received light into a data signal comprising proximity data, from which the presence of the object 2 can be determined.

The sensor also comprises a register 5 with processing parameters such as a baseline reference value, being a reference/nominal value of an average of the data signal when there is no object 2 close enough to reflect light back to the receiver 4 (i.e. no target condition). Other processing parameters typically include threshold values for triggering a calibration (or a request for calibration), and a baseline window size for calculating the average of the data signal. The register 5 is typically comprised by a local memory in the sensor. Typically, the register 5 is maintained by application software, e.g. when the sensor is used with a mobile device. For example, application software may determine suitable values for the thresholds for a particular application and update the register 5 accordingly.

The sensor comprises a processing unit 6 for processing the data signal. The processing unit 6 can access the register 5 and use the processing parameters to correctly process the data signal. E.g. the processing unit 6 may subtract a crosstalk value from the data signal to separate the “true” proximity data from crosstalk.

The processing unit 6 is configured to calculate a baseline value of the data signal by taking an average of the data signal using a number of data points equal to the baseline window size. The processing unit 6 is configured to compare the data signal to a no target threshold value and only calculate the baseline value under a no target condition (i.e. when the data signal is below the threshold). For example, the processing unit 6 may be configured to ignore data points with a value greater than the no target threshold value in the calculation of the baseline value.

If the difference between the baseline value and the baseline reference value exceeds a threshold value, then the processing unit 6 is configured to determine if there is a change in temperature and/or a “smudge” in front of the sensor (a smudge is defined as any semi-permanent disturbance in the optical path of the sensor, such as a grease or dirt on a smartphone screen).

To detect a temperature change, the processing unit 6 is configured to compare the current temperature as measured by a temperature sensor 7 to a nominal temperature.

The nominal temperature is typically the temperature measured by the temperature sensor 7 at the last calibration and stored in the register 5. The processing unit 6 is configured to compare the absolute difference between the current temperature and nominal temperature to a temperature threshold value. If the difference exceeds the threshold, then the processing unit 6 determines that a calibration of the proximity sensor is required. In response, the processing unit 6 may be configured to trigger an auto calibration of the proximity sensor, or to request calibration from an external unit 8 (e.g. mobile device such as a smartphone with application software). For example, the processing unit 6 may set a temperature flag to 1 and send an interrupt to the external unit 8. If the external unit 8 considers a calibration necessary, it sends a calibration request to the proximity sensor, which performs the calibration in response. During calibration, the nominal temperature value stored in the register 5 is updated.

To detect a smudge, the processing unit 6 is configured to calculate the baseline value of the data signal over a time period represented by a number of cycles (i.e. over a number of consecutive baseline windows sizes) to determine if the baseline value remains above (or below) a smudge threshold value over that time period. The register 5 comprises a persistence value, which determines the number of cycles and hence the time period. The persistence value may be user/application defined, and takes into account the semi-permanent characteristics of a smudge (as opposed to a transient object briefly obstructing the sensor). If the baseline value remains above (or below) the smudge threshold over the time period, then the processing unit 6 determines that a smudge is present (or has been removed) and consequently determines that a calibration is required. For example, the processing unit 6 may set a smudge flag to 1 and send an interrupt to the external unit 8, or the processing unit 6 may trigger an auto-calibration.

The proximity sensor is configurable so that application software can set how the sensor responds to detecting a smudge and/or temperature change. For example, application software of the external unit 8 may configure the register 5 such that the processing unit 6 responds by automatically calibrating the proximity sensor each time a smudge and/or temperature change is detected. Alternatively, the register can be configured such that processing unit 6 only flags the “problem” to the application software, and then performs a calibration in response to receiving a prompt.

The processing unit 6 may also be configured to trigger a calibration when the proximity sensor is turned on (i.e. when switched from off to on). In general, the proximity sensor is turned off when configurations setting are changed, which may affect crosstalk. Hence, instead of checking if the settings, and as a consequence the crosstalk, has changed, the proximity sensor is automatically calibrated when the device 1 is turned on again.

The optical device 1 has the advantage of not requiring an additional emitter or receiver for detecting a smudge, but can use the data signal provided by the normal emitter 3 and receiver 4. Furthermore, because the optical device 1 is configured to process the data signal to determine the presence of a smudge, the data signal does not have to be constantly transmitted to and analyzed by external application software. Hence, more processing is performed directly at the optical device 1. This can significantly decrease the traffic load on the optical device output. For example, the optical device 1 may communicate with the external unit 8 over an I2C connection. Because the processing unit of the optical device 1 determines if calibration is required, only calibration triggers/requests and status flags (e.g. smudge flag=1) need to be transmitted over the I2C connection, rather than the whole data signal.

The external unit 8 can influence the data processing at the optical device 1 by setting the values of at least some processing parameters in the register 5. For example, if a quick response to a change in crosstalk is required, then a small baseline window size can be set.

FIG. 2 shows a schematic diagram of a system 9 comprising an optical device 1 such as the proximity sensor depicted in FIG. 1 in a smartphone 10. The same reference numerals are used in different figures for equivalent or similar features in order to aid understanding and are not intended to limit the illustrated embodiments. The smartphone 10 may be the external unit 8 illustrated in FIG. 1. In use, the optical device may be used to determine the presence and/or distance to a user of the smartphone 10.

FIG. 3 shows a schematic diagram of a system 9 comprising an optical device 1 such as the proximity sensor in FIG. 1 a display 11 (e.g. a LED or OLED display) and a cover glass 12. The display 11 and cover glass 12 may be part of a smartphone such as the smartphone 10 illustrated in FIG. 2. A smudge 13 is located on the cover glass in front of the optical device 1. Whilst FIG. 3 shows the optical device 1 located next to the display 11, in other embodiments the optical device 1 may be located below the display 11.

The optical device 1 emits light 14, which is transmitted through the cover glass 12. Light scattering from the smudge 13 increases the optical crosstalk at the receiver of the optical device 1 and thereby increases the baseline value of the data signal provided by the receiver. The optical device 1 is configured to detect this increase in the baseline value of the data and to determine that there is a smudge in front of the device 1. In response, the optical device 1 may trigger a crosstalk calibration to update the crosstalk value that is being subtracted from the data signal.

If and when the smudge 13 is removed, the optical crosstalk will decrease. The optical device 1 is configured to detect this change and to determine that the smudge has been removed. In response, the device 1 can trigger another crosstalk calibration to update the crosstalk value to be subtracted from the data signal.

FIG. 4 shows a flow diagram illustrating the sequence of steps taken by a proximity sensor according to an embodiment.

Starting from an “IDLE” state, if “Calibration Enable”=1, then the sensor performs a calibration and sets “calib_finished”=1.

If “Prox. Enable”=0, then the sensor goes back into the “IDLE” state.

If “Prox. Enable”=1 (i.e. the proximity sensor is enabled to make proximity measurements), then the sensor performs “Run Proximity” and “Compute BSLN” (i.e. determine the baseline value of the proximity data signal).

If the baseline value is within bounds (i.e. the absolute difference between the calculated baseline value and a baseline reference value is below a threshold), the sensor repeats “Run Proximity” and “Compute BSLN”. Otherwise, the sensor performs “Detect Smudge & Temperature Change” (i.e. determine if there is a change in temperature or a smudge in front of the sensor, which has caused a change to the crosstalk).

The sensor then checks “Smudge or Temp Change Detected?”. If no change in temperature and no smudge is detected, the sensor goes back to “Run Proximity” and

“Compute BSLN”. Otherwise, the sensor performs “Assert Interrupt” (i.e. an interrupt is sent to trigger a calibration request from an external unit) if this is enabled.

The sensor then checks if “Calibration Enable”=1 (i.e. a calibration request has been received) or “auto_calib_trigger_en” (i.e. sensor auto calibration is enabled), in which case the sensor performs a calibration. Otherwise, the sensor goes back to “Run Proximity” and “Compute BSLN”.

The averaging window for calculating the baseline value is configurable. The interrupt can be enabled or disabled. “Prox. Enable” and “Calibration Enable” are user controlled (e.g. controlled by application software).

In an embodiment, the proximity sensor may execute the following three steps to detect a condition to trigger calibration.

### 1. Baseline (BSLN Data) Measurement:

The baseline is an average of proximity data. The average window size can be configured as 2, 4, 8, 16, 32 etc. (in multiples of 2). The proximity data for baseline computation is considered only when there is no target. This can be done by updating the BSLN average only when Proximity data is less than a programmable ‘No Target’ data threshold (NT-Limit) and the device is in the detect mode (i.e. the screen is ON and no target is close). At the end of the BSLN average window, the computed baseline value (BSLN_DATA) is compared against the software configured reference baseline value (I2C_REF_BSLN_DATA).

If |BSLN_DATA−I2C_REF_BSLN_DATA|>BSLN_DELTA_THR then, a flag (‘bsIn_ovr_thr’) is set and the algorithm proceeds to a temperature measurement and smudge detection phase. The BSLN_DELTA_THR is software programmable register, which sets the difference threshold for the measured and reference baseline data. Only the magnitude of the difference is considered for the above comparison. This allows the sensor to track both an increase and decrease of the measured baseline.

### 2. Temperature Measurement and Comparison:

An on-chip temperature sensor (e.g. a thermistor) is used to measure & detect a temperature change in coarse steps.

Temperature can measured by the device under the following two scenarios:
a) After every calibration cycle to record the reference temperature data (CALIB_TEMP_DATA) which will be used for comparison in the subsequent proximity measurement cycles; and
b) After normal proximity measurement when BSLN data is over the threshold. The data can be stored in a TEMP_DATA register.

If |TEMP_DATA−CALIB_TEMP_DATA|>TEMP_DELTA_THR then a flag, (‘temp_ovr_thr’) is set. The TEMP_DELTA_THR is software programmable register which sets the difference threshold for the measured and reference temperature data.

If ‘bsin_ovr_thr’=1 & ‘temp_ovr_thr’=1, then request for calibration is triggered for the application software, an interrupt can also be generated and optionally a calibration cycle can be auto triggered.

### 3. Smudge Detection:

If the BSLN is over the threshold, then temperature measurement is done followed by the Smudge detection. A smudge is represented by a constant (or semi-permanent) shift in proximity data and not drift. The algorithm can use this concept to detect a smudge. The smudge detection is performed by checking the baseline data after persistence filtering. During the smudge detection state, the BSLN data is compared against a software programmable ‘SMDG_THR’ threshold.

If BSLN_DATA>SMDG_THR for N consecutive BSLN cycles, then a flag (‘smdg_detected’) is set. N is the persistence filter setting & can take values=0 (Every time BSLN crosses the threshold), 1 (2 times BSLN crosses the threshold), 2, 3, . . . M.

If ‘bsIn_ovr_thr’=1 & ‘smdg_detected’=1, then request for calibration is triggered for the application software, an interrupt also can be generated and optionally a calibration cycle can be auto triggered.

FIG. 5 shows a graph of a proximity data signal 15 over time in relation to different processing parameters. In the beginning, the data signal is close to the baseline reference value 16 (i2c_ref_bsln=nt_data). Followed by large fluctuations in a region 17. Within the region 17, the data signal goes outside the baseline threshold values 18 and 19 (bsin_del_threshold_+ and bsin_del_threshold_−). However, because the baseline value is an average (over a baseline window) and/or because the persistence value filters transient changes in crosstalk, no smudge is detected at this point. While the signal 15 is fluctuating in the region 17, at a point 20 it briefly goes above the no target threshold value 21 (NT_Limit). Data at this point 20 can be ignored and not used for computing the baseline value.

After the large fluctuations, the baseline value settles above the smudge threshold value 22 (smudge_threshold+). In a region 23, since the baseline value is below the no target threshold value 21, but greater that the smudge threshold value 22 over a number of cycles equal to the persistence value, a smudge is detected. A smudge detected flag=1 may be set.

After the smudge is detected, large fluctuation in the signal 15 occur in region 24. Again, the window size for computing the baseline value and the persistence value filter out these rapid changes in the proximity data. Data points in the region 25 above the no target threshold value 21 are ignored.

The signal 15 settles below the lower smudge threshold 26 (smudge_threshold−). In a region 27, since the baseline value is below the no target threshold value 21, and below the lower smudge threshold value 26 over a number of cycles equal to the persistence value, a smudge is detected (in this case it is the removal of a smudge). A smudge detected flag=1 may be set.

As seen in FIG. 5, whenever the proximity data changes rapidly, the data is ignored for the algorithm. Whenever the baseline settles outside the smudge threshold and is within the ‘No Target’ limit for N (N=persistence value) consecutive cycles, the algorithm alerts the host and can also perform auto calibration to compensate for the smudge.

Accordingly, a request/trigger for calibration can be executed under the following condition: (bsIn_ovr_thr=1) & ((temp_ovr_thr=1)|(smdg_detected=1)).

Embodiments described herein can provide several advatages over conventional devices. There is no requirement for additional emitters, sensors, analog front end or special packaging to detect the presence or removal of a smudge. For a proximity sensor, the same circuitry that is used to measure the proximity is used to detect a smudge without depending on any other external circuitry. The sensor can detect the change in conditions with regards to a temperature change, the presence/removal of a smudge, as well as a change in configuration that impact the crosstalk and consequently the proximity data. Additionally, the sensor can request/trigger a calibration to mitigate the impact caused by those factors.

The optical device provides flexibility through user programmable registers to configure the range through threshold and reference values and to configure the response time through a baseline average window and a persistence value (filter size). The device thereby provides options to customize the calibration algorithm based on the application in the field. The device can provide a two-step process of checking the baseline data (long time averaged data) followed by monitoring the temperature change and smudge presence. The device can improve the reliability of detecting the conditions for triggering calibration. Furthermore, because the data signal is processed at the device, it can remove the overhead on the host/software to track the data range that is used to detect a smudge.

Although specific embodiment have been described above, the claims are not limited to those embodiments. Each feature disclosed may be incorporated in any of the described embodiments, alone or in an appropriate combination with other features disclosed herein.

Reference Numerals

| | |
|---|---|
| 1 | Optical Device |
| 2 | Object |
| 3 | Emitter |
| 4 | Receiver |
| 5 | Register |
| 6 | Processing unit |
| 7 | Temperature sensor |
| 8 | External unit |
| 9 | System |
| 10 | Smartphone |
| 11 | Display |
| 12 | Cover glass |
| 13 | Smudge |
| 14 | Emitted light |
| 15 | Data signal |
| 16 | Baseline reference value |
| 17 | Region with large fluctuations |
| 18 | Baseline threshold value |
| 19 | Baseline threshold value |
| 20 | Data points above no-target threshold |
| 21 | No-target threshold |
| 22 | Smudge threshold |
| 23 | Region with smudge detected |
| 24 | Region with large fluctuations |
| 25 | Data points above no-target threshold |
| 26 | Lower smudge threshold |
| 27 | Region with smudge detected |

1. An optical device comprising:
an emitter for emitting light;
a receiver for receiving reflected light and providing a data signal;
a register for storing processing parameters comprising a baseline reference value; and
a processing unit for processing the data signal using the processing parameters, wherein the processing unit is configured to
compare the data signal to the baseline reference value, and
determine that a crosstalk calibration of the optical device is required based at least partially on the comparison.

2. An optical device according to claim 1, wherein the processing unit is configured to, in response to determining that crosstalk calibration is required,
perform the crosstalk calibration, or
flag to an external unit that a crosstalk calibration is required, wherein the processing unit is configured to receive a calibration trigger from the external unit and, in response to receiving the calibration trigger, perform the crosstalk calibration.

3. An optical device according to claim 2, wherein the register is configurable by the external unit.

4. An optical device according to claim 1, wherein the crosstalk calibration comprises determining a crosstalk value being indicative of a level of optical crosstalk at the receiver, and wherein the processing unit is configured to subtract the crosstalk value from the data signal.

5. An optical device according to claim 1, wherein the processing parameters comprise
a baseline window size, and
a no-target threshold value,
and wherein the processing unit is configured to determine a baseline value of the data signal by taking an average of the data signal in a window having the baseline window size while ignoring data signal values exceeding the no-target threshold, and wherein the processing unit is configured to compare the data signal to the baseline reference value by comparing the baseline value to the baseline reference value.

6. An optical device according to claim 5, wherein the processing parameters comprise a baseline threshold value, and wherein comparing the baseline value to the baseline reference value comprises calculating an absolute difference between the baseline value and the baseline reference value and determining when the absolute difference exceeds the baseline threshold value.

7. An optical device according to claim 6, wherein the register comprises
a persistence value indicative of a time period, and
a smudge threshold value,
and wherein the processing unit is configured to
in response to determining that the absolute difference exceeds the baseline threshold value, determine if the baseline value exceeds the smudge threshold value over the time period, and
in response to determining that the baseline value exceeds the smudge threshold value over the time period, determine that a crosstalk calibration is required.

8. An optical device according to claim 6, further comprising a temperature sensor for determining a temperature of the optical device, wherein the processing parameters comprise a temperature threshold value, and wherein the processing unit is configured to
in response to determining that the absolute difference exceeds the baseline threshold value, compare the temperature of the optical device to the temperature threshold value, and
when the temperature of the optical device exceeds the temperature threshold value, determine that a crosstalk calibration is required.

9. An optical device according to claim 1, wherein the processing unit is further configured to determine that a crosstalk calibration is required when the optical device is turned on.

10. An optical device according to claim 1, wherein the optical device is a proximity sensor and the data signal is a proximity data signal usable to determine a presence of or a distance to an object reflecting light emitted by the emitter and received by the receiver.

11. A system comprising:
a proximity sensor according to claim 10; and
a mobile device connected to the proximity sensor and comprising application software, wherein the application software is configured to
set and maintain one or more of the process parameters in the register of the proximity sensor,
receive a request for crosstalk calibration from the proximity sensor, and
in response to receiving the request, determine whether or not to send a calibration trigger to the proximity sensor to cause the crosstalk calibration.

12. A method of determining the presence of and/or distance to an object, the method comprising:
emitting light from an emitter;
receiving with a receiver light comprising light emitted from the emitter and reflected by the object;
providing from the receiver a data signal usable for determining the presence of and/or the distance to the object;
providing a register comprising processing parameters for processing the data signal comprising a baseline reference value;
comparing the data signal to the baseline reference value;
determining that a crosstalk calibration is required based at least partially on the comparison; and
determining the presence of and/or the distance to the object from the data signal.

13. The method of claim 12, further comprising, in response to determining that a crosstalk calibration is required,
performing the crosstalk calibration, or
flagging to an external unit that a crosstalk calibration is required, receiving a calibration trigger from the external unit and, in response to receiving the calibration trigger, performing the crosstalk calibration.

14. The method of claim 12, wherein the processing parameters comprise
a baseline window size,
a baseline threshold value, and
a no-target threshold value, and the method further comprises:
determining a baseline value of the data signal by taking an average of the data signal in a window having the baseline window size while ignoring data signal values exceeding the no-target threshold value; and
comparing the data signal to the baseline reference value by taking an absolute difference between the baseline value and the baseline reference value and determining when the absolute difference exceeds the baseline threshold value.

15. The method of claim 14, wherein the register comprises
a persistence value indicative of a time period, and
a smudge threshold value, and the method further comprises:
in response to determining that the absolute difference exceeds the baseline threshold value, determining if the baseline value exceeds the smudge threshold value over the time period; and
in response to determining that the baseline value exceeds the smudge threshold value over the time period, determining that a crosstalk calibration is required; and/or
wherein the register comprises a temperature threshold value and the method comprises:
in response to determining that the absolute difference exceeds the baseline threshold value, measuring a temperature;
comparing the temperature to a nominal temperature; and
when an absolute difference between the temperature and the nominal temperature exceeds the temperature threshold value, determining that a crosstalk calibration is required.
